(19) United States
(12) Patent Application Publication
(10) Pub. No.: US 2005/0271539 A1
(43) Pub. Date: Dec. 8, 2005

(54) Method of production of diamond elements

(75) Inventor: Luca Risso, Genova (IT)

Correspondence Address: HESLIN ROTHENBERG FARLEY & MESITI PC, 5 COLUMBIA CIRCLE, ALBANY, NY, 12203, US

(73) Assignee: MIMITALIA S.r.l., Vado Ligure (Savona) (IT)

(21) Appl. No.: 11/129,427

(22) Filed: May 13, 2005

(30) Foreign Application Priority Data
May 18, 2004 (IT) TO2004A000328

(51) Int. Cl. B32B 3/10

(52) U.S. Cl. 419/11

(57) ABSTRACT

A diamond element, for example an insert for wire saws, is produced by means of a method that comprises the steps of: preparation of a starting mixture of metal dusts; plasticizing of the starting mixture by means of specific plastic additives; addition of diamond granules; injection moulding by means of MIM technology; removal of the plastic additives; sintering; and infiltration with a Cu/Ag eutectic alloy or another infiltrating alloy.

### CROSS-REFERENCE TO RELATED APPLICATIONS

This application claims priority from Italian Patent Application No. TO2004A000328 filed on May 18, 2004, the entire disclosure of which is incorporated herein by reference.

### FIELD OF THE INVENTION

The present invention relates to diamond tools, and more in particular:
to diamond inserts for wires used for cutting blocks in marble and granite quarries, as well as for the production of plates and for cutting concrete in interventions in the sector of conservation building works; and
to diamond segments and more in general to any sintered diamond abrasive component, especially if it is one of a complex shape.

### STATE OF THE PRIOR ART

Traditionally, the technologies of production of diamond inserts of which the diamond wire is constituted consist in dry pressing of a mixture of metal dusts—typically Co, Fe, WC, W, Cu, Sn—and diamond granules in dies made of steel or hard metal, followed by sintering. On the other hand, hot-pressing systems using sintering machines are being abandoned on account of the fact that they are far from economically viable.

The starting compositions are constituted by a mixture with variable formulation made up of:
1) fine metal dust, normally having a diameter of between 1 μm and 10 μm, amongst which, for example but not exclusively, Ni, Cu, Fe, Sn, and Zn;
2) a metal binder, usually cobalt;
3) coarse granules of industrial synthetic diamond; and
4) granules of abrasive or reinforcing material (for example, but not exclusively, SiO₂, WC, WC/W₂C, B₄C, SiC, TiC, Mo₂C, CrC, Al₂O₃, in grain sizes up to 250 μm).

The high pressures linked to the friction between the mixture of dusts and the parts of the die, as well as between the different parts of the die themselves, reached during forming of the dusts, usually bring about onset of defects due to the heterogeneity of the mixture and hence of the distribution of the stresses in the die. This is true, in particular, in the step of extraction after compression (formation of cracks and chips). Furthermore, the distribution of the pressure within the die is inhomogeneous, since it is substantially higher in the proximity of the point of contact between the mixture and the force plug (i.e., the part of the die that exerts the force of compression). The traditional technology of compression with cold dies limits the possibility of producing diamond tools with substantially simple shapes. Another drawback related to said conventional technologies is linked to the presence of the diamond, which exerts a considerable abrasive action on the dies, causing fast wear thereof.

The US patent application No. US-2002/0178862 divulges the application of technologies such as metal injection moulding (MIM) to the production of dies made of an alloy of tungsten-cobalt carbide, envisaging the successive steps of preparation of an alloy of tungsten-cobalt carbide with possible addition of other compounds or elements, mixing with plastic additives, injection moulding with MIM technology, removal of the plastic additives, and finally sintering. The sintering temperatures specifically indicated in the prior document No. US2002/0178862 (up to 1370° C.) are not compatible with the production of inserts with diamonds in the form of granules.

### SUMMARY OF THE INVENTION

A purpose of the present invention is to provide a method of production of diamond elements and inserts that will enable the drawbacks described above to be overcome, i.e., will enable a reduction in the forming pressures of the tools and hence in the wear of the dies, exploiting the advantages of known technologies, such as MIM.

A further purpose of the present invention is to reduce substantially the defectiveness in the moulding step. Yet a further purpose of the invention consists in guaranteeing a high homogeneity in the distribution of the pressure within the pressed component. Another purpose of the invention is to guarantee the possibility of obtaining even complex shapes.

The above purposes are achieved via a method applied to a mixture of metal dusts and diamond granules comprising the following successive steps:
1) preparation of a starting mixture of metal dusts;
2) plasticizing of the starting mixture of metal dusts by means of addition of plastic additives specific for injection moulding of metal dusts (MIM process);
3) addition of diamond granules with a grain size comprised between 10 μm and 300 μm by means of hot plasticizing, homogenization, cooling, and granulation;
4) injection moulding (MIM) at both high and low pressure of said mixture for obtaining diamond elements of the desired shape;
5) removal of the plastic additives;
6) sintering of the diamond elements; and
7) infiltration of the sintered inserts with a eutectic alloy for the elimination of any residual porosities.

Sintering of the diamond elements can be performed at temperatures comprised between 900° C. and 1100° C. It is also possible to perform the sintering operations with hot-isostatic-pressing (HIP) or hot-pressing technologies. There may likewise be envisaged a possible further final HIP step.

The preferred formulations of the starting mixture of dusts are listed in the following table:

| | Co | Fe | WC | W | Cu | Sn | |
|---|---|---|---|---|---|---|---|
| | (wt %) | (wt %) | (wt %) | (wt %) | (wt %) | (wt %) | Diamond (wt %) |
| Formulation 1 | 10-90 | 10-90 | 0-50 | — | | | 0.5-5 |
| Formulation 2 | 10-90 | 10-90 | 0-50 | 0-50 | | | 0.5-5 |
| Formulation 3 | 10-90 | 10-90 | 0-50 | 0-50 | 0-30 | | 0.5-5 |
| Formulation 4 | 10-90 | 10-90 | 0-50 | 0-50 | 0-30 | 0-30 | 0.5-5 |

The grain size of the dust of Co, Fe, WC, W, Cu and Sn is conveniently comprised between 0.01 μm and 100 μm.

The grain size of the diamond grit is typically comprised between 10 and 200 meshes (meshes according to B.S.I. 1943, Tyler 1910 and US Standard 1940).

The plastic additives used can be chosen, for example, from:
1) thermoplastic mixtures with a base of polyolefins such as: polyethylene, polypropylene, ethylvinyl acetate, wax, stearic acid;
2) water-soluble thermoplastic mixtures with a base of polyvinyl alcohol, cellulose compounds and polysaccharides;
3) polyacetalic thermoplastic mixtures; and
4) thermosetting mixtures.

Mixing of the metal dusts with the plastic additives is a hot mixing process performed, for example, in devices of the double-screw extruder type or double-roller mixer type.

The diamond grit is subsequently added by means of hot plasticizing, homogenization, cooling and granulation. For this step a planetary mixer with Z-shaped blades or Σ-shaped blades can, for example, be used.

The mixture thus obtained is then injection-moulded using MIM (metal-injection moulding) technology with the following critical parameters: pressure comprised between 1 bar and 1000 bar, and temperature comprised between 50° C. and 300° C.

There are thus obtained diamond moulded bodies, which are then subjected to de-waxing, i.e., removal of the plasticizing additive.

De-waxing can, for example, be carried out in different alternative ways:
1) using heat by means of thermal treatment in ovens in a controlled atmosphere or air;
2) using organic solvents, such as alcohol, benzene, cylene, etc., or else aqueous solvents; and
3) by means of catalysis in ovens saturated with nitric acid.
   Then the moulded and de-waxed bodies thus obtained undergo sintering.

Sintering is carried out typically in an industrial hydrogen furnace, with characteristic temperatures comprised between 900° C. and 1100° C. It is possible also to carry out sintering with HIP or else hot pressing.

The mixture formed by pressing and then sintered may next possibly be subjected to infiltration with a Cu/Ag eutectic alloy or another infiltrating alloy for the purpose of filling any possible residual porosities present in the inserts.

The elements or inserts thus obtained (each normally provided with a central metal support) are finally mounted on a metal cable to obtain wires that can be used for cutting blocks in marble and granite quarries, as well as for the production of plates and for cutting concrete in interventions in the sector of conservation building works.

Thanks to the method described, a reduction in the pressures of forming of the tools is possible—and hence in the wear of the dies—as likewise a greater homogeneity is obtained in the density of the green compact formed by pressing and consequently a better homogeneity of the physico-mechanical characteristics of the finished product. It is moreover possible to obtain products even of a complex shape as well as to use conveniently MIM technology for the production of diamond inserts, with evident savings in terms of production costs.

The invention affords said advantages thanks to the peculiarity of the combined steps of the method claimed, said combination presenting as an original way of overcoming technical prejudice up to the present day linked to alleged insurmountable operating difficulties in relation to recourse to MIM technologies for forming the diamond elements.

Of course, the modalities and steps of the method may vary widely with respect to what is described merely by way of example herein, without thereby departing from the scope of the present invention as defined in the ensuing claims. Thus, the application of the invention to diamond inserts for diamond wires for cutting is provided purely as an example. An equally advantageous application may in fact be envisaged for the production of diamond segments, which could be in future the main application, and new shapes that have so far not been produced will be possible thanks to the versatility proper to the MIM process.

1. A method of production of diamond elements, such as diamond inserts for wires for cutting and the like, comprising the successive steps of:
preparation of a starting mixture of metal dusts;
plasticizing of the starting mixture of metal dusts by means of addition of plastic additives specific for injection moulding of metal dusts;
addition of diamond granules with grain size comprised between 10 μm and 300 μm;
injection moulding by means of MIM (metal injection moulding) technology of the mixture thus obtained for obtaining diamond elements having the desired shape;
removal of the plastic additives;
sintering of the diamond elements thus obtained; and
infiltration of the sintered elements with a eutectic alloy for elimination of any residual porosities.

2. The method according to claim 1, in which said starting mixture of metal dusts is selected among the following formulations:

| | Co | Fe | WC | W | Cu | Sn |
|---|---|---|---|---|---|---|
| | (wt %) | (wt %) | (wt %) | (wt %) | (wt %) | (wt %) |
| Formulation 1 | 10-90 | 10-90 | 0-50 | — | | |
| Formulation 2 | 10-90 | 10-90 | 0-50 | 0-50 | | |
| Formulation 3 | 10-90 | 10-90 | 0-50 | 0-50 | 0-30 | |
| Formulation 4 | 10-90 | 10-90 | 0-50 | 0-50 | 0-30 | 0-30 |

3. The method according to claim 1, in which the grain size of the original metal dust is comprised between 0.01 μm and 100 μm.

4. The method according to claim 1, in which the added diamond granules have a weight percentage comprised between 0.5 wt % and 5 wt % of the mixture.

5. The method according to claim 1, in which the plastic additives are chosen in one of the following classes:
a. thermoplastic mixtures with a base of polyolefins such as: polyethylene, polypropylene, ethylvinyl acetate, wax, stearic acid;
b. water-soluble thermoplastic mixtures with a base of polyvinyl alcohol, cellulose compounds and polysaccharides;
c. polyacetalic thermoplastic mixtures; and
d. thermosetting mixtures.

6. The method according to claim 1, in which the addition of plastic additives to the mixture of dusts occurs in hot conditions in a double-screw extruder.

7. The method according to claim 1, in which the addition of plastic additives to the mixture of dusts occurs in hot conditions in a double-roller mixer.

8. The method according to claim 1, in which the addition of diamond granules occurs by means of a planetary mixer with Z-shaped blades.

9. The method according to claim 1, in which the addition of diamond granules occurs by means of a planetary mixer with sigma-shaped blades.

10. The method according to claim 1, in which removal of the plastic additives occurs by heat in a controlled atmosphere or air.

11. The method according to claim 1, in which removal of the plastic additives occurs using organic solvents.

12. The method according to claim 1, in which removal of the plastic additives occurs via aqueous solvents.

13. The method according to claim 1, in which removal of the plastic additives occurs by means of catalysis in ovens saturated with nitric acid or oxalic acid.

14. The method according to claim 1, in which injection moulding according to the MIM technology occurs with pressures of between 1 bar and 1000 bar.

15. The method according to claim 1, in which injection moulding according to the MIM technology occurs at temperatures of between 50° C. and 300° C.

16. The method according to claim 1, in which sintering is performed at temperatures of between 900° C. and 1000° C.

17. The method according to claim 1, in which sintering is performed by means of HIP or hot pressing.

18. The method according to claim 1, in which the infiltration eutectic alloy is a Cu/Ag alloy.

19. The method according to claim 2, in which the grain size of the original metal dust is comprised between 0.01 μm and 100 μm.
